(19) United States
(12) Patent Application Publication
(10) Pub. No.: US 2024/0161625 A1
(43) Pub. Date: May 16, 2024

(54) MOTION ACTIVATED PARKING GUIDE

(71) Applicant: Clint Thomas Dumas, Henderson, NV (US)

(72) Inventor: Clint Thomas Dumas, Henderson, NV (US)

(21) Appl. No.: 18/335,215

(22) Filed: Jun. 15, 2023

Related U.S. Application Data
(60) Provisional application No. 63/425,336, filed on Nov. 15, 2022.

(51) Int. Cl. G08G 1/16; G08G 1/01

(52) U.S. Cl. CPC G08G 1/168; G08G 1/01

(57) ABSTRACT

A motion activated parking guide for automatically displaying the distance between a stationary obstruction and a vehicle is disclosed. A telemetry module is used to store and track position data from range sensors. The telemetry module uses the stored data to calculate the velocity of the moving object in view. When motion is detected the telemetry module will display distance information in numeric form to the vehicle driver. Input elements are provided to the telemetry module to allow the vehicle driver to configure the numeric display properties. A power pack is provided for electrical components.

### CROSS REFERENCE TO THE RELATED APPLICATIONS

This application is based upon and claims priority to U.S. Provisional Application No. 63/425,336, filed on Nov. 15, 2022, the entire contents of which are incorporated herein by reference.

### TECHNICAL FIELD

The present disclosure relates to a motion activated parking apparatus. More specifically, the present disclosure relates to a motion activated parking apparatus for displaying the distance between a moving object and a stationary detector.

### BACKGROUND

Many vehicles are equipped with parking guide systems. However, many vehicles are not equipped with parking guide systems. Existing parking devices are focused on maneuvering the vehicle to a pre-determined location. The ideal distance between the obstruction and the vehicle is generally pre-set, and the user does not have discretion on the overall location. In some instances, control of the vehicle is taken away from the user.

Previous methods of guiding a vehicle into confined spaces with fixed obstructions, such as a garage, include: physical objects that use contact with the vehicle as a means of positioning; optical guides that use reflection or sources of light as a means of positioning; mounted laser lights that use a projection to guide the user to a known location; electronic devices with sensors to detect an object has reached a fixed location; and/or general stop-light style parking sensors. Self-driving cars taking control away from the driver and parking the car itself also guides a vehicle to a pre-determined location.

With the previous parking systems, the user is provided with a fixed location or an adjustable pre-determined fixed location, focusing on getting as close as possible to the obstruction, or control is taken away from the driver. Even the previous systems that are adjustable require the user to park first, and then adjust the device to set the ideal location. There is no way to set up a device that will allow the user to park close one day and allow clearance room the next. The user must decide on one location before use, a singular fixed result.

The act of parking is considered secondary to the location of the parked vehicle, the primary concern was the end resulting location with current parking systems. The act of parking needs to be treated as the primary concern. The dynamic activity of objects in motion needs to be considered.

Accordingly, what is needed a parking guide that will allow a user to position any moving object at any desired distance from a fixed obstruction, and particularly what is needed is a motion activated parking guide mounted on a stationary object that automatically displays the exact distance between the stationary object and a moving vehicle in real time on a numeric display that does not require the user to have a predetermined location.

### SUMMARY

The disclosed invention relates to a motion activated parking guide for automatically displaying the distance between a stationary obstruction such as a wall and a moving object such as a vehicle on a numeric display provided on the motion activated parking guide. The motion activated parking guide may be mounted to a stationary obstruction such as a wall in plan view of the user in the moving object such as vehicle. The user is able to readily observe the numeric display that provides the distance between the stationary obstruction such as a wall and the moving object such as a vehicle. The disclosed invention does not require the user to have a predetermined location when parking the vehicle. The motion activated parking guide of the present invention displays information about the vehicle in motion when the vehicle is sensed by a sensor mounted to a stationary device.

Disclosed is a motion activated parking guide comprising: a housing mounted to a stationary obstruction; at least one range sensor mounted on the stationary obstruction; a telemetry module mounted within the housing, the telemetry module configured to receive data from the at least on range sensor; and a numeric display provided on the housing, the numeric display showing a distance from the telemetry module to a vehicle in motion. The motion activated parking guide may further comprise a controller in communication with a program and data memory module to track the data received from the at least one range sensor. The motion activated parking guide may further comprise input elements to configure the data from the telemetry module to the numeric display module. The stationary obstruction may be a wall. The at least one range sensor may be an ultrasonic range sensor. The at least one range sensor may be a laser sensor. The at least one range sensor may be an infrared sensor. The at least one range sensor may be a plurality of motion sensors. The numeric display module may be an LED display module. The numeric display module may be an LED matrix display module. The numeric display module may be an LCD display module. The motion activated parking guide may further comprise a power pack to supply power to the at least one range sensor, the numeric display and said telemetry module. The vehicle may be in drive. The vehicle may be in reverse.

### BRIEF DESCRIPTION OF THE DRAWINGS

In order to more clearly illustrate the embodiments of the present disclosure, a brief description of the drawings is given below. The following drawings are only illustrative of some of the embodiments of the present disclosure and for a person of ordinary skill in the art, other drawings or embodiments may be obtained from these drawings without inventive effort.

FIG. 1 is a schematic view of one embodiment of a vehicle in relation to a motion activated parking guide according to the invention;

FIG. 2 is a schematic view of a second embodiment of a vehicle in relation to a motion activated parking guide according to the invention;

FIG. 3 is a schematic view of the second embodiment of a vehicle in relation to a motion activated parking guide according to the invention;

FIG. 4 is a schematic view of a third embodiment of a vehicle in relation to a motion activated parling guide according to the invention;

FIG. 5 is a block diagram of a motion activated parking guide according to the invention;

FIGS. 6A and 6B show perspective views of a base plate according to the invention;

FIG. 7A is a perspective view of a reverse side of a base plate according to the invention;

FIGS. 7B, 7C, and 7D are side, back and front views of a base plate according to the invention;

FIGS. 8A and 8B are plan views of front and back sides of a base plate according to the invention;

FIG. 9A is a perspective of a housing according to the invention;

FIGS. 9B and 9C are bottom and side views of a housing according to the invention;

FIGS. 10A and 10B are perspective views of a housing according to the invention;

FIGS. 11A and 11B are top and front views of a housing according to the invention;

FIG. 12 is a plan view of a back side of a circuit board according to the invention;

FIG. 13 is a plan view of a front side of a circuit board according to the invention;

FIGS. 14A, 14B, and 14C are perspective views of a sonar case according to the invention;

FIG. 15A is a plan view of a top surface of a sonar case according to the invention;

FIGS. 15B, 15C, 15D, and 15E are side views about a sonar case according to the invention; and

FIG. 16 is a block diagram of the operation of a motion activated parking guide according to the invention.

### DETAILED DESCRIPTION

The technical solutions of the present disclosure will be clearly and completely described below with reference to the drawings. The embodiments described are only some of the embodiments of the present disclosure, rather than all of the embodiments. All other embodiments that are obtained by a person of ordinary skill in the art on the basis of the embodiments of the present disclosure without inventive effort shall be covered by the protective scope of the present disclosure.

In the present invention, a final parking location or a vehicle are not considered. There is no requirement for a final set desired location, any desired final location can be achieved. Any object could be used, there is no requirement for it to be a passenger vehicle, it can be a semi-trailer, a pallet of goods being moved by a forklift, a motorcycle, an RV, or any object, the main focus is that there is a stationary obstruction that needs to be protected, and the parking guide of the present invention aids in that protection by providing users in the area information regarding the clearance distance to the stationary obstruction.

The combination of a numeric display and the dynamic tracking of motion within a telemetry module allow the user to make real time decisions on when an object is in the ideal location. Tracking the dynamic motion of the object can eliminate issues that are found when different objects are used. By tracking the dynamic motion of the object, the errors in the measurements of the position of the object can be mitigated. By providing the user with a numeric display, enough information is provided to the user, so the user can make exact quantitative measurements, instead of a generalized qualitative distance.

A motion activated parking guide for automatically displaying the distance between a stationary obstruction and a moving object or vehicle is disclosed. In operation, the motion activated parking guide assists a user in guiding a vehicle into a desired parking location by displaying the distance away from the vehicle and a stationary obstruction, such as wall or pole. This allows the motion activated parking guide to stay idle when the vehicle is stationary and automatically begins operation when the vehicle begins moving.

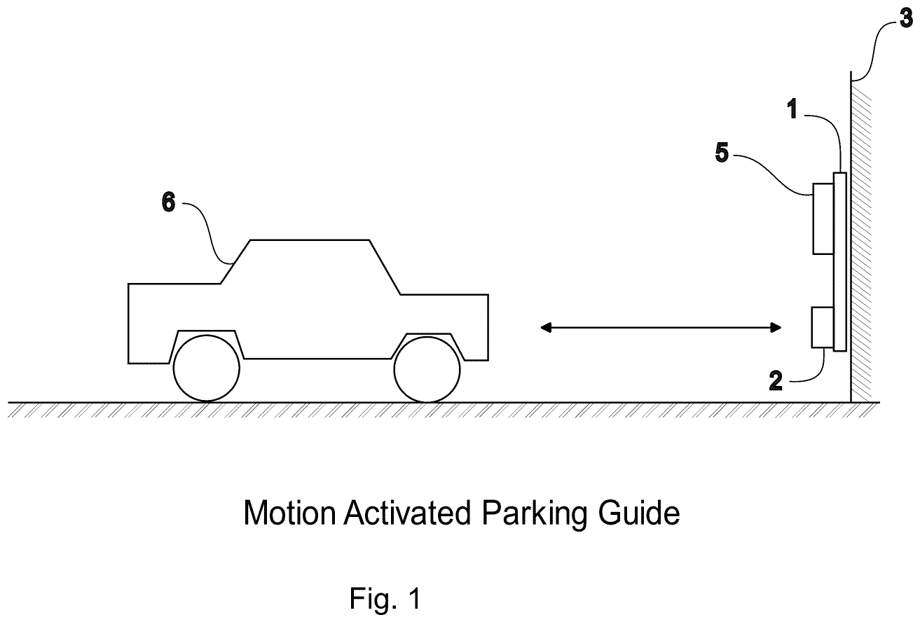

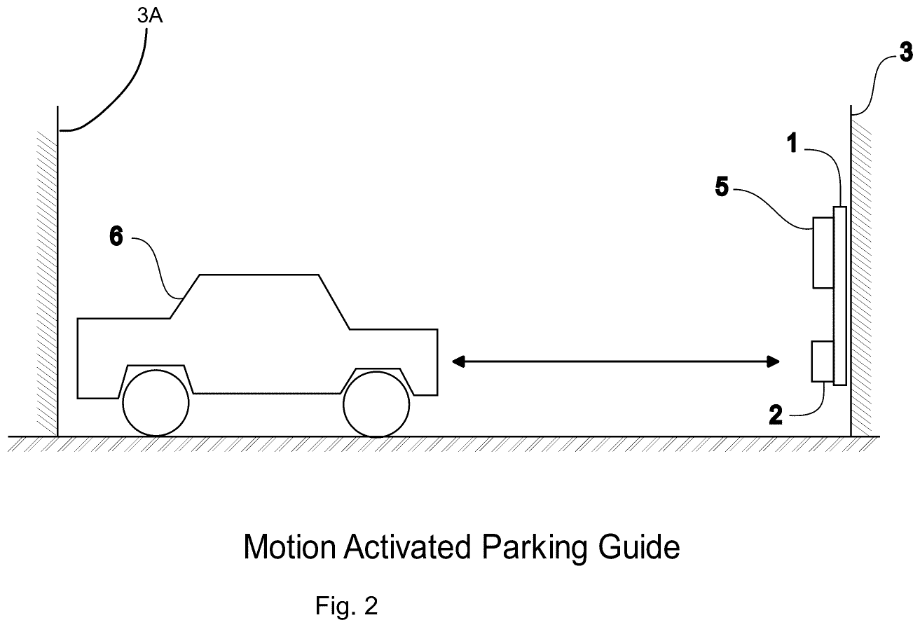

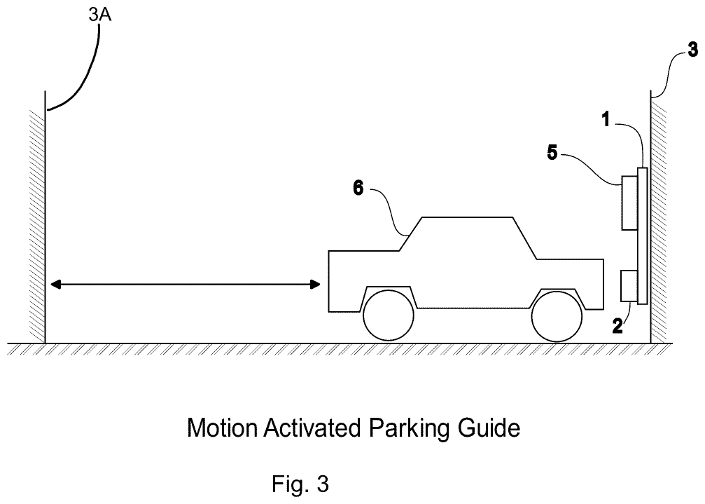

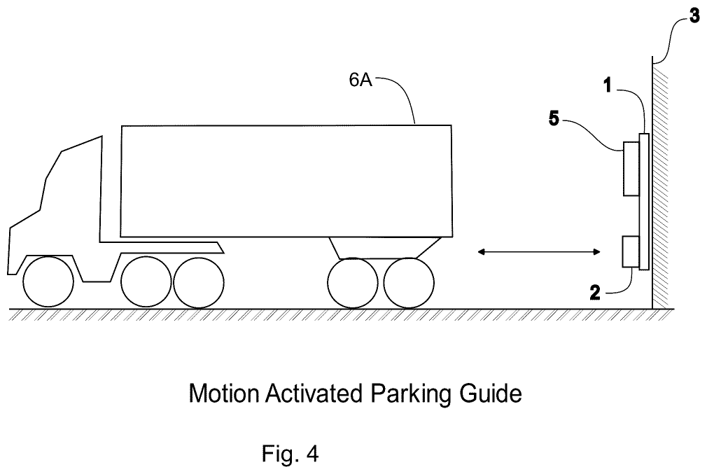

FIGS. 1, 2, 3 and 4 illustrate various embodiments showing a moving object 6, such as a vehicle being parked. In a first embodiment shown in FIG. 1, a motion activated parking guide 1 is mounted to a stationary obstruction 3, such as a wall. A numeric display 5 is provided on motion activated parking guide 1 so that numeric display 5 is in clear view of a user or driver. At least one range sensor 2 is provided on motion activated parking guide 1. In a second embodiment shown in FIGS. 2 and 3, an additional obstruction 3A, such as a wall, is shown opposite from the stationary obstruction 3. In a third embodiment shown in FIG. 4, a different moving object 6A, such as a tractor trailer, is being parked with the motion activated parking guide 1.

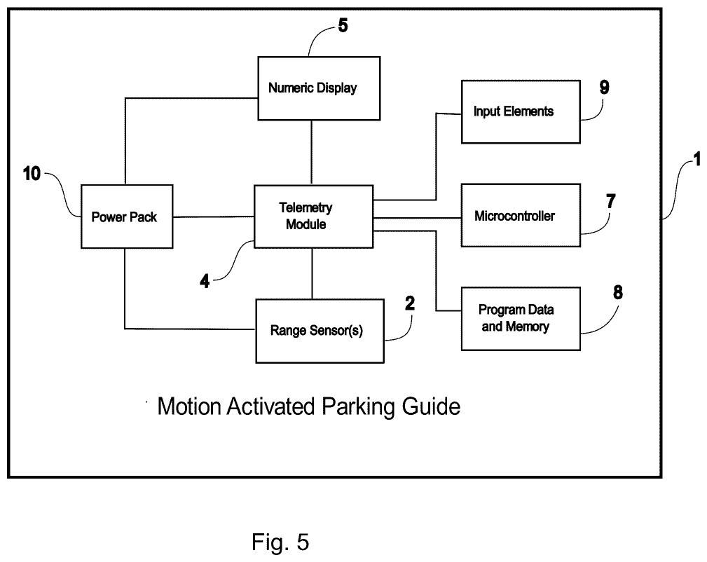

FIG. 5 shows a schematic block diagram of a motion activated parking guide 1 Motion activated parking guide 1 is provided with at least one range sensor 2, numeric display 5, and a telemetry module 4. Motion activated parking guide 1 is further provided with input elements 9, controller or microcontroller 7, and program and data memory module 8. A power pack 10 is provided to supply voltage to numeric display 5, telemetry module 4 and at least one range sensor 2. Telemetry module 4 in turn provides voltage to input elements 9, controller or microcontroller 7 and program and data memory module 8.

Numeric display 5 may be a digital numeric LED display module that can receive data from controller or microcontroller 7. Numeric display 5 may also be an LED matrix, LCD display or other suitable display modules configured to provide a numeric value to the user.

At least one range sensor 2 may be a sonic or ultrasonic range sensor configured to provide distance measurements to controller or microcontroller 7. At least one range sensor 2 may also be a laser, infrared, or other suitable range sensors configured to send distance information to controller or microcontroller 7. A plurality of range sensors may be used.

Telemetry module 4 cooperates with controller or microcontroller 7 and program and data memory module 8 in order to store and track distance information from at least one range sensor 2 and calculates telemetry data, distance, and velocity for motion detection. Input elements 9 are used to set functions in controller or microcontroller 7. Input elements 9 may be buttons configured to display brightness, text direction, and distance units. Input elements 9 may also be switches, jumpers, or other suitable electrical input elements, such as a touch screen on numeric LED display 5. Power pack 10 provides voltage to electronic components.

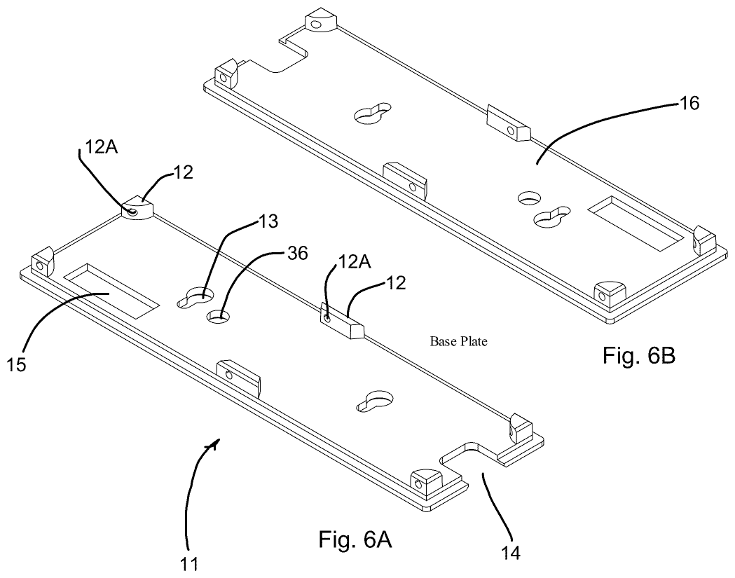

FIGS. 6A and 6B, show base plate 11 of motion activated parking guide 1 having a plurality of protrusions 12, each with a fastener opening 12A. Base plate 11 is provided with multiple key hole shape apertures 13, a large rectangular opening 15 and a lateral edge recess 14. Base plate 11 has a lower planar surface 16 extending along the entire length thereof.

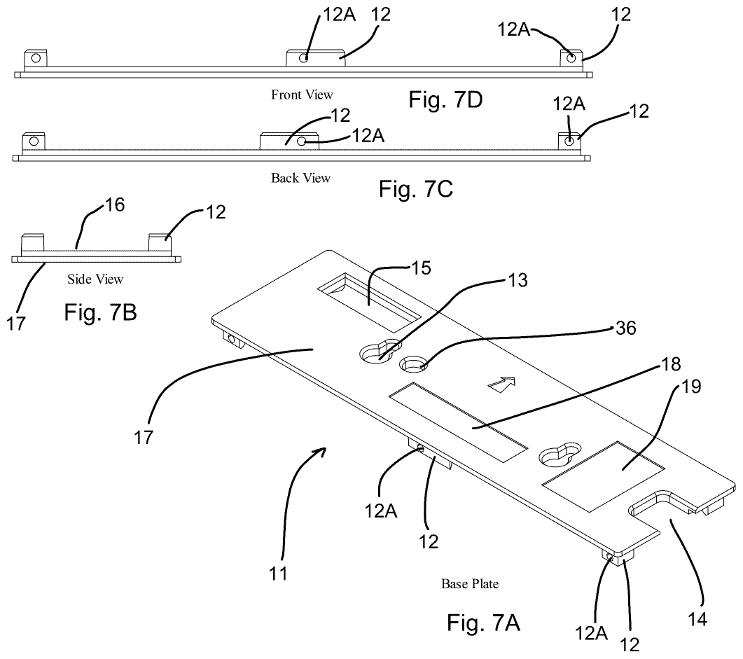

FIG. 7A shows base plate 11 on its reverse side exhibiting an upper planar surface 17 extending along the entire length thereof. Upper planar surface 17 is provided with a longitudinal rectangular recess 18 and a transverse rectangular recess 19. FIGS. 7B, 7C, and 7D show side views of base plate 11.

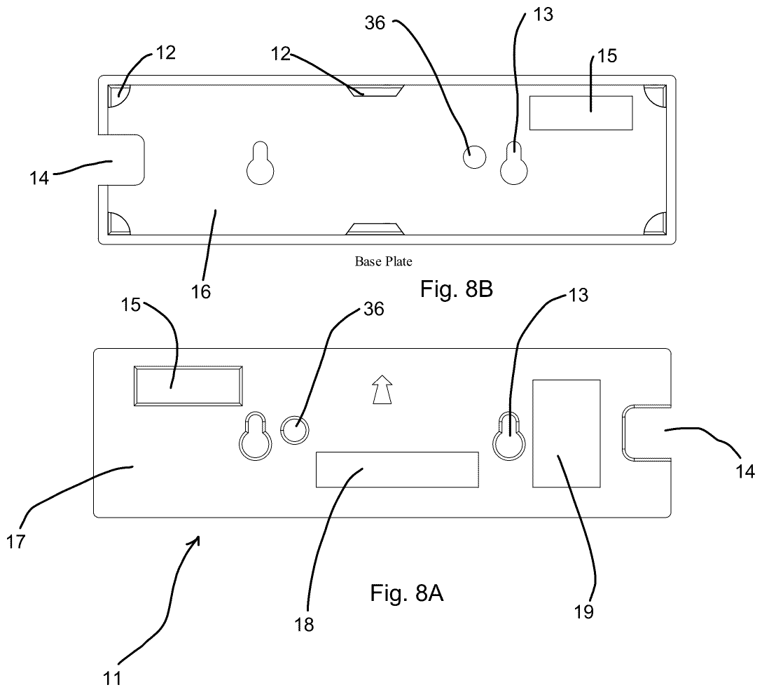

FIG. 8A shows a top plan view of base plate 11 having a large rectangular opening 15, longitudinal rectangular recess 18 and transverse rectangular recess 19 along upper planar surface 17. FIG. 8B shows the reverse side of base plate 11 provided with lower planar surface 16 having multiple key hole shaped apertures 13, large rectangular opening 15 as well as a singular circular aperture 36.

The base plate 11 is mounted to a longitudinally extending housing 20. Plurality of protrusions 12 may be formed as a raised plastic portion to mount base plate 11 to the longitudinally extending housing 20. Fastener opening 12A provides an attachment point for base plate 11 to the longitudinally extending housing 20. A fastener (not shown) may be a plastic clip or screw. Multiple keyhole shaped apertures 13 provide wall mounting holes that allow the motion activated parking guide 1 to be attached to the stationary obstruction 3 by way of fasteners, such as screws (not shown). Lateral edge recess 14 provides an insert area of the base plate 11 to allow access to screw terminals (not shown) that allow low voltage AC or DC power sources to be used in the power pack 10. Large rectangular opening 15 provides an access hole in the base plate 11 to allow the user to access the input elements 9 of the motion activated parking guide 1.

Lower planar surface 16 is provided as an interior surface of the base plate 11. Upper planar surface 17 is provided as an exterior surface of the base plate 11. The longitudinal rectangular recess 18 is provided as an insert area of the base plate 11 which allows the motion activated parking guide 1 to be attached to the stationary obstruction 3 by double sided taped, hook and loop fasteners, or general adhesives. Transverse rectangular recess 19 provides an insert area of base plate 11 which allows the manufacturer to include serial and model information as a printed sticker, engraving or other identification labels. Singular circular aperture 36 provides an access hole in base plate 11 to allow the user to access input elements 9 of the motion activated parking guide 1, such as a reset button (not shown).

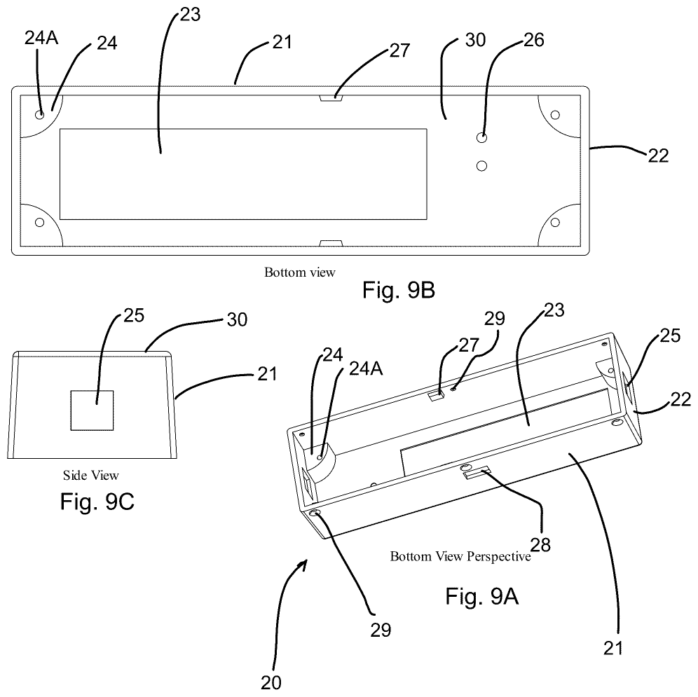

FIGS. 9A, 9B and 9C show longitudinally extending housing 20 having longitudinal side walls 21 and end walls 22. Corner protrusions 24 having fastener openings 24A are provided within longitudinally extending housing 20. A large longitudinally extending opening 23 is provided in a top wall 30 of longitudinally extending housing 20. A pair of small circular apertures 26 are provided in top wall 30. Side wall protrusions 27 are provided on an inner surface of longitudinal side wall 21. A rectangular side wall aperture 28 is provided in one of the longitudinal side walls 21. Further, multiple fastener apertures 29 are provided in each of longitudinal side walls 21. End wall rectangular openings 25 is provided in each of end walls 22.

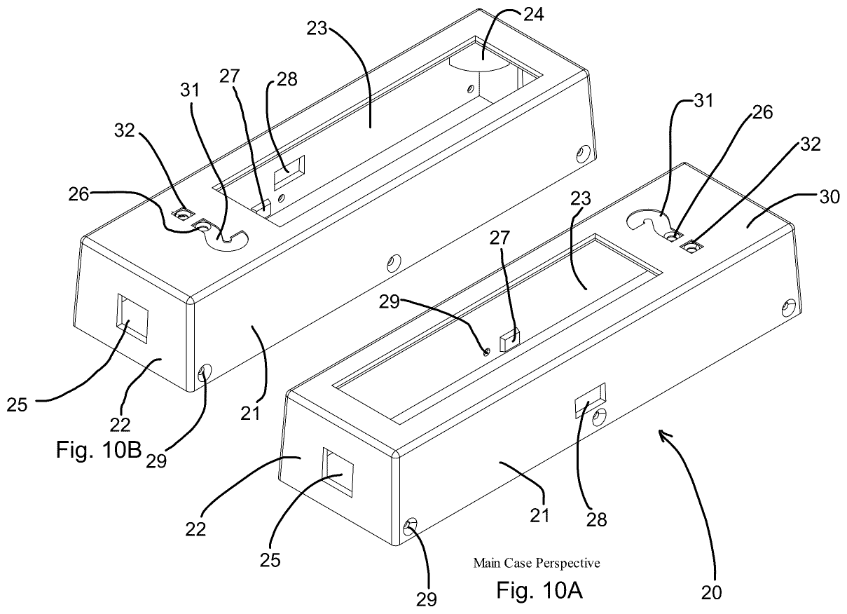

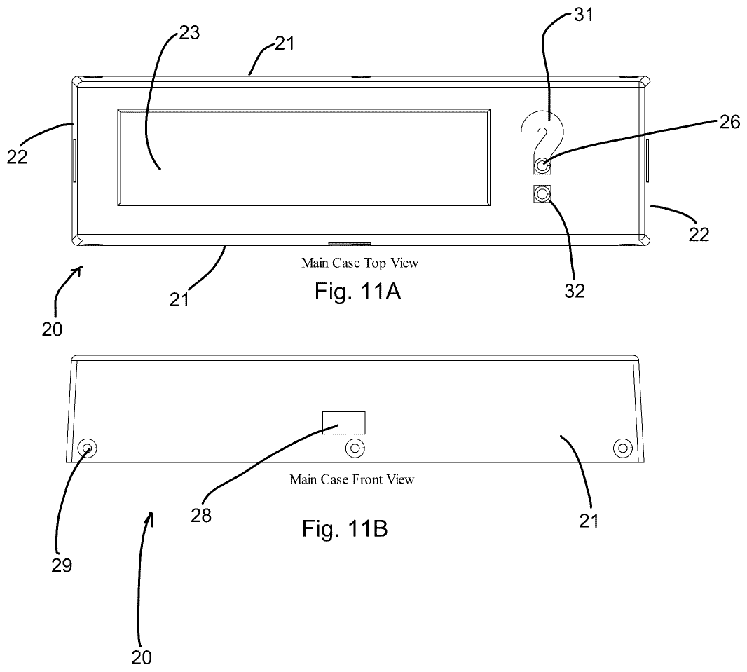

FIGS. 10A and 10B show longitudinally extending housing 20 in its perspective top view. A first shaped recess 31 and a second shaped recess 32 are provided about each of small circular apertures 26. FIGS. 11A and 11B show top and side views of longitudinally extending housing 20.

Longitudinally extending housing 20 is provided as a plastic casing that protects numeric display 5, power pack 10, microcontroller 7, and other electronic elements, such as input elements 9. Longitudinal side wall 21 is provided as a side panel of longitudinally extending housing 20. End walls 22 are provided as end panels of the longitudinally extending housing 20. Large longitudinally extending opening 23 is provided as a hole in longitudinally extending housing 20 that allows the user to view the numeric display 5. Corner protrusion 24 is provided as a raised element of longitudinally extending housing 20 to support circuit board 33. Fastener opening 24A is provided as a hole in corner protrusion 24 to mount circuit board 33 via a fastener (not shown). End wall rectangular opening 25 is provided as a hole in each of the end walls 22 of longitudinally extending housing 20. One of the end wall rectangular openings 25 is provided as a DC/AC power connection to the power pack 10 and the other end wall rectangular opening 25 provides a USB power connection to the power pack 10. A pair of small circular apertures 26 are provided as a pair of holes in top wall 30 of the longitudinally extending housing 20 for LED(s) to indicate the motion activated parking guide 1 is being supplied power from power pack 10.

Side wall protrusion 27 is provided on longitudinal side wall 21 to ensure longitudinally extending housing 20 and base plate 11 are aligned properly when coupled together. Rectangular side wall aperture 28 is provided as a hole in the longitudinally extending housing 20 to allow power and signal wires to at least one range sensor 2. Multiple fastener apertures 29 are provided about the longitudinally extending housing 20 in order to attach longitudinally extending housing 20 to base plate 11, with a fastener, such as a plastic clip or screw (not shown). First shaped recess 31 provides an insert area of longitudinally extending housing 20 that allows the manufacturer to include their logo. Second shaped recess 32 provides a hole in longitudinally extending housing 20 for LED(s) to indicate status and errors from microcontroller 7. Further, the pair of small circular apertures 26 are respectively provided in first and second shaped recesses 31 and 32.

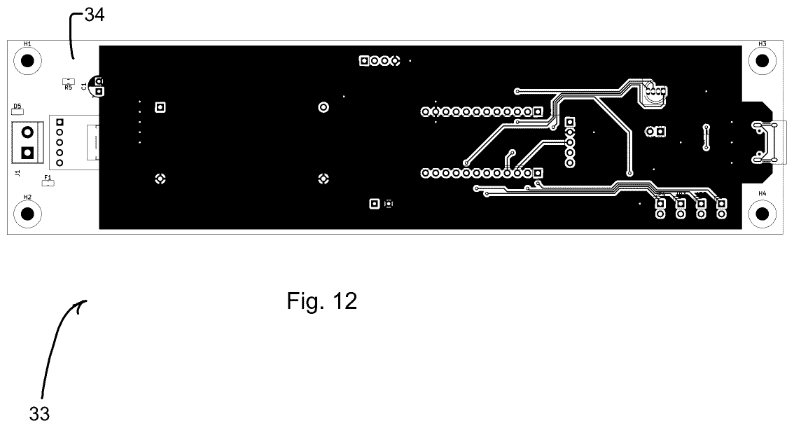

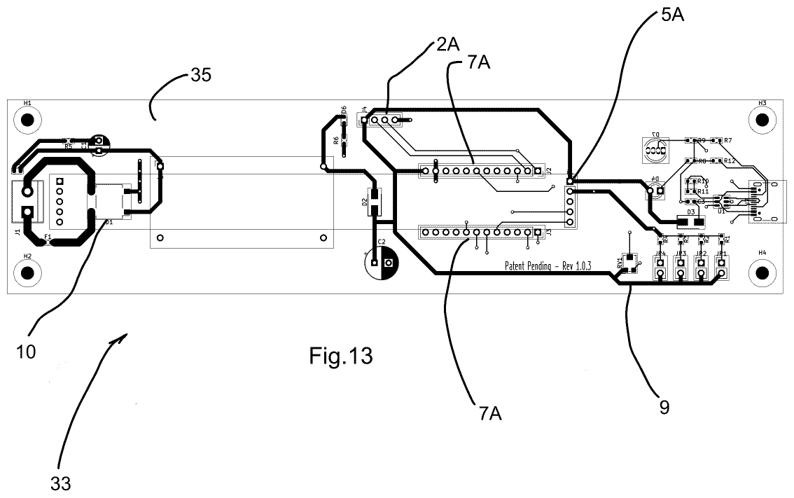

FIGS. 12 and 13 show circuit board 33 having a lower surface 34 (See FIG. 12) and an upper surface 35 (See FIG. 13). FIG. 12 shows a rear view of circuit board 33. Lower surface 34 provides a digital printout of copper traces and silkscreens used on the back of circuit board 33.

FIG. 13 shows a front view circuit of circuit board 33. Upper surface 35 provides a digital printout of copper traces and silkscreens used on the front of circuit board 33. FIG. 13 shows upper surface 35 provided with power pack 10 at one end portion of circuit board 33. Pins 2A of sonar sensor 2 are provided in a middle portion of upper surface 35 of circuit board 33. Pins 7A of microcontroller 7 are provided in the middle portion of circuit board 33. Pins 5A of numeric display 5 are provided adjacent pins 7A in the middle portion of circuit board 33. Input elements 9 are provided at an opposite end portion of circuit board 33.

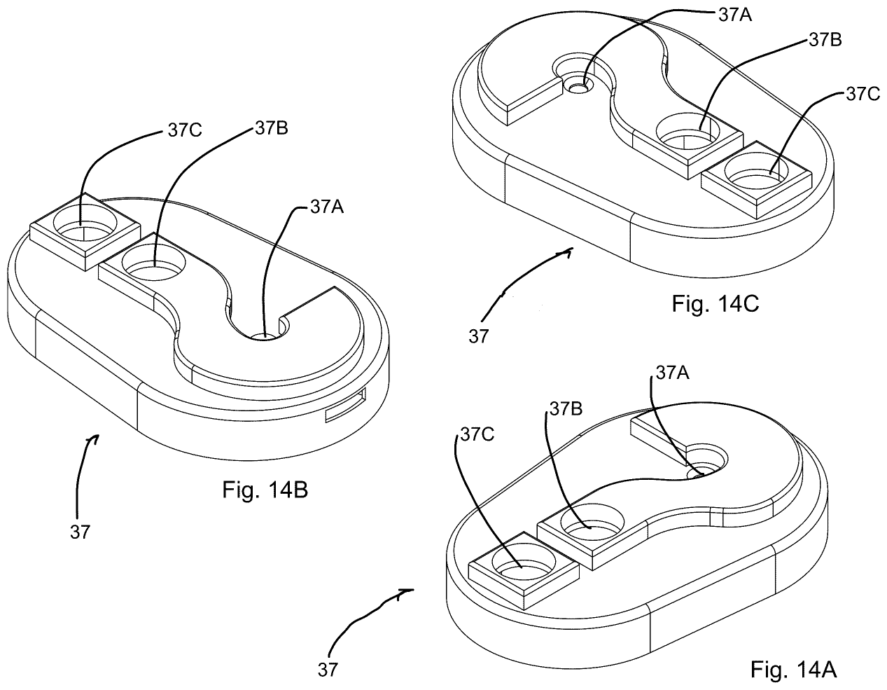

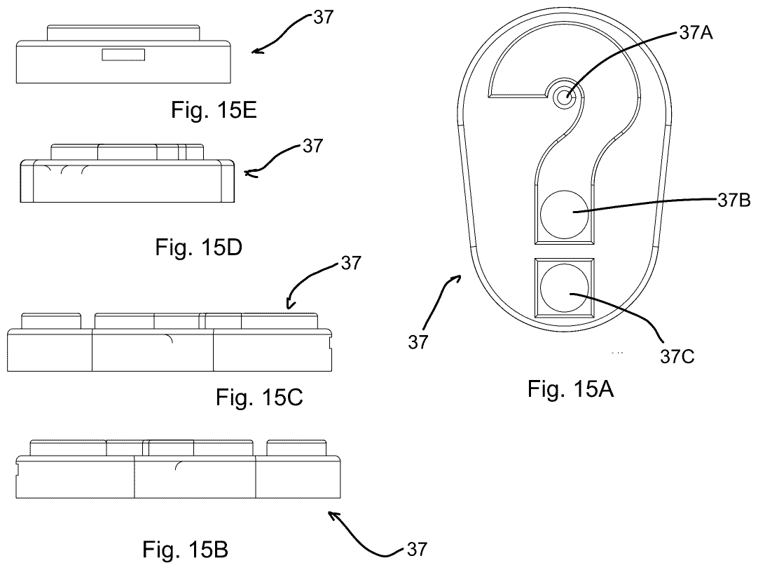

FIGS. 14A, 14B, 14C, and 15 show various views of sonar housing or case 37 housing at least one range sensor 2. Circuit board 33 is received within (not shown) longitudinally extending housing 20.

Sonar housing or case 37 is provided as a plastic case having an ornamental design in order to house at least one range sensor 2. Sonar housing or case 37 is provided with hole 37A that allows the user to mount sonar housing or case 37 to stationary obstruction 3 with a fastener, such as a screw (not shown). Sonar housing or case 37 is also provided with holes 37B and 37C to accommodate at least one range sensor 2.

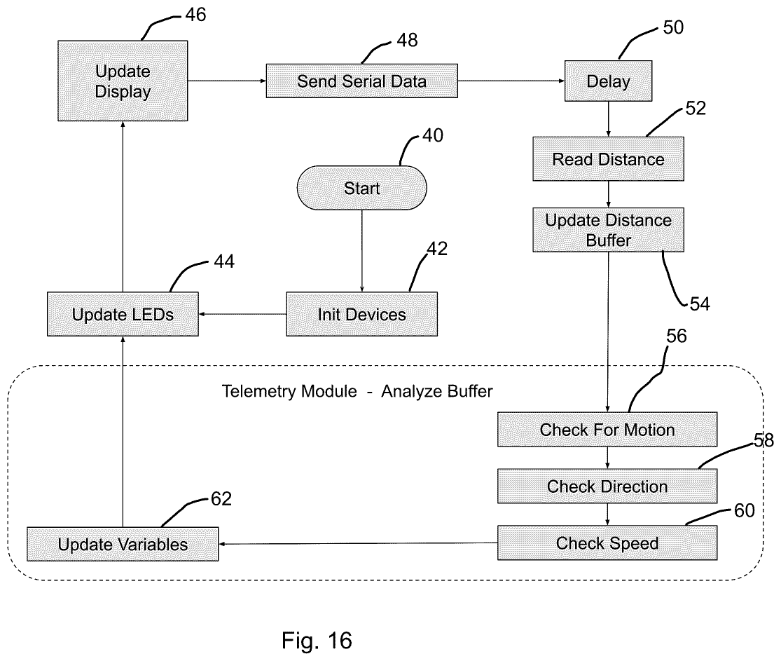

A block diagram of the operation of motion activated parking guide 1 is shown in FIG. 16. The motion activated parking guide is initially powered off, when powered on, the device enters the starting point 40 and proceeds automatically to initialize peripherals in process 42, then it enters a recursive loop process. Starting with the process to update LED 44, then update display 46, send serial data 48, delay 50, read distance 52 update distance buffer 54, check for motion 56, check direction 58, check speed 60, and update variables 62. After a few iterations of the loop, the telemetry module will have enough information to decipher when an object approaches the stationary obstruction and can update the display accordingly.

FIG. 16 shows the software components that make up the program and data memory module 8 used on controller or microcontroller 7 and telemetry module 4. Each block in the diagram represents a discrete step in the overall algorithm used to produce the motion activated parking guide 1 behavior. Entry point 40 is for the executable binary program and data memory module 8 in controller or microcontroller 7 which is responsible for starting up the software components. This subprocess 40 sets up program and data memory module 8, with distance buffer 54, and application variables 62 are created with initial values. Subprocess 42 handles peripheral electronic device initialization. Some components, such as numeric display 5, and at least one range sensor 2 may need communication channels, and software interfaces loaded into memory. Data available from input elements 9 are also updated. If there are any errors that occur while starting these components, the variables created during the initialization stage at entry point 40 are updated so that the status shown during step 44 and the text rendered in step 46 are correct.

Subprocess 44 updates the status of LED(s) using the values available in application variables from subprocess 40 or 62. Subprocess 46 renders text on numeric display 5 using values available in application variables from subprocess 40 or 62. Subprocess 48 sends diagnostic data (application variables 62) is sent to a serial port on the parking guide 1 for external troubleshooting. In subprocess 50 a timing delay occurs to allow time for motion to occur. This also sets up distance buffer 54 with equal time spacing per memory unit. In subprocess 52 the controller or microcontroller 7 accesses the at least one range sensor 2 available information. In subprocess 54 the controller or microcontroller 7 stores the at least one range sensor 2 available information into program and data memory module 8. Subprocess 56 analyzes data in distance buffer 54 to check for motion, and stores that motion information in program and data memory module 8.

Subprocess 58 analyzes the motion information from subprocess 56 to check for direction. Subprocess 60 analyzes motion information from subprocess 56 to check for speed. Subprocess, 62 of telemetry module 4 analyzes data regarding distance from subprocess 54, direction from subprocess 58, and speed from subprocess 60. The estimated trajectory of moving object 6 is calculated. The application variables in memory regarding the display state, real time distance, and overall status are updated. Data available from input elements 9 is also updated. Control of the application is passed back to subprocess 44 so the application will continue in a recursive loop.

The above-mentioned embodiments of the present disclosure are only examples for describing the present disclosure more clearly, rather than limiting an implementation mode of the present disclosure. For those of ordinary skill in the art, other variations or changes in different forms can be made on the basis of the above description. It is impossible to list all implementation methods here. The obvious variations or changes derived from the technical solutions of the present disclosure still fall within the scope of protection of the present disclosure.

1. A motion activated parking guide comprising:
a housing mounted to a stationary obstruction;
at least one range sensor mounted on the stationary obstruction;
a telemetry module mounted within the housing, the telemetry module configured to receive data from the at least on range sensor; and
a numeric display module provided on the housing, wherein the numeric display module showing a distance from the telemetry module to a vehicle in motion.

2. The motion activated parking guide of claim 1, further comprising a controller in communication with a program and data memory module to track the data received from the at least one range sensor.

3. The motion activated parking guide of claim 1, further comprising input elements to configure the data from the telemetry module to the numeric display module.

4. The motion activated parking guide of claim 1, wherein the stationary obstruction is a wall.

5. The motion activated parking guide of claim 1, wherein the at least one range sensor is an ultrasonic range sensor.

6. The motion activated parking guide of claim 1, wherein the at least one range sensor is a laser sensor.

7. The motion activated parking guide of claim 1, wherein the at least one range sensor is an infrared sensor.

8. The motion activated parking guide of claim 1, wherein at least one range sensor is a plurality of motion sensors.

9. The motion activated parking guide of claim 1, wherein the numeric display module is an LED display module.

10. The motion activated parking guide of claim 1, wherein the numeric display module is an LED matrix display module,

11. The motion activated parking guide of claim 1, wherein the numeric display module is an LCD display module.

12. The motion activated parking guide of claim 1, further comprising a power pack to supply power to the at least one range sensor, the numeric display and the telemetry module.

13. The motion activated parking guide system of claim 1, wherein the vehicle is in drive.

14. The motion activated parking guide system of claim 1, wherein the vehicle is in reverse.
